(19) United States
(12) Patent Application Publication
(10) Pub. No.: US 2025/0301517 A1
(43) Pub. Date: Sep. 25, 2025

(54) METHOD, COMMUNICATION SYSTEM, AND ELECTRONIC DEVICE

(71) Applicant: CASIO COMPUTER CO., LTD., Tokyo (JP)

(72) Inventors: Shuhei UCHIDA, Tokyo (JP); Takashi ITOH, Tokyo (JP); Munetaka SEO, Tokyo (JP); Takeshi MATSUE, Tokyo (JP); Hiroaki OOTSUBO, Tokyo (JP)

(73) Assignee: CASIO COMPUTER CO., LTD., Tokyo (JP)

(21) Appl. No.: 19/064,438

(22) Filed: Feb. 26, 2025

(30) Foreign Application Priority Data
Mar. 22, 2024 (JP) 2024-046418

(51) Int. Cl. H04W 76/14; H04W 48/10; H04W 48/16

(52) U.S. Cl. CPC H04W 76/14; H04W 48/10; H04W 48/16

(57) ABSTRACT

A method for a system that includes a first electronic device, a second electronic device, and a third electronic device, in which the method includes: transmitting, by the first processor, a wireless signal, which is a signal repetitively output at a time interval including at least a first time interval, via the first communication device; connecting, by the second processor, the first electronic device and the second electronic device via the second communication device, based on scanning for the wireless signal; and scanning, by the first processor, for the wireless signal for connecting with the third electronic device, repetitively at a time interval including at least a second time interval shorter than the first time interval, based on the connection between the first electronic device and the second electronic device.

### CROSS-REFERENCE TO RELATED APPLICATIONS

This application claims the benefit of priority based on Japanese Patent Application No. 2024-046418 filed on Mar. 22, 2024, in Japan, and incorporates the entire content of the application herein by reference.

### BACKGROUND OF THE INVENTION

### Field of the Invention

The present disclosure relates to a method, a communication system, and an electronic device.

### Related Art

Wristwatch-type smartwatches wirelessly connected to smartphones are increasingly used as convenient communication terminals equipped with functions to notify users of incoming calls and emails to smartphones, as well as call functions. Smartwatches and smartphones are typically connected via wireless communication using the communications standard of Bluetooth Low Energy (hereinafter referred to as “BLE”), which consumes relatively low power. In BLE communication, a slave device called “peripheral” transmits a wireless signal called “advertisement signal” with a predetermined period, while a master device called “central” executes scanning at a predetermined interval. When the central detects the advertisement signal, the central requests pairing with the peripheral, thereby establishing wireless connection. Due to dimensional constraints of the shape and dimension, smartwatches generally have smaller battery capacities compared to other devices such as smartphones. Therefore, power consumption required for communication connections with a plurality of devices becomes an issue.

### SUMMARY OF THE INVENTION

One aspect of the present disclosure is a method for a system including: a first electronic device including a first processor and a first communication device that executes wireless communication; a second electronic device including a second processor and a second communication device that executes wireless communication; and a third electronic device including a third processor and a third communication device that executes wireless communication, in which the method includes: transmitting, by the first processor, a wireless signal, which is a signal repetitively output at a time interval including at least a first time interval, via the first communication device; connecting, by the second processor, the first electronic device and the second electronic device via the second communication device, based on scanning for the wireless signal; and scanning, by the first processor, for the wireless signal for connecting with the third electronic device, repetitively at a time interval including at least a second time interval shorter than the first time interval, based on the connection between the first electronic device and the second electronic device.

### BRIEF DESCRIPTION OF THE DRAWINGS

FIG. 1A is a schematic diagram illustrating the overall configuration of a communication system according to one embodiment of the present disclosure;

FIG. 1B is a schematic diagram illustrating the overall configuration of a communication system according to one embodiment of the present disclosure;

FIG. 2 is a block diagram illustrating an example of the hardware configuration of a portable wireless device according to one embodiment of the present disclosure;

FIG. 3 is a block diagram illustrating an example of the hardware configuration of a portable terminal device according to one embodiment of the present disclosure;

FIG. 4 is a block diagram illustrating an example of the functional block configuration of a portable wireless device according to one embodiment of the present disclosure;

FIG. 5 is a block diagram illustrating an example of the functional block configuration of a portable terminal device according to one embodiment of the present disclosure;

FIG. 6 is a sequence diagram illustrating a connection sequence in the communication system according to one embodiment of the present disclosure;

FIG. 7A is a schematic diagram illustrating the overall configuration of a communication system according to another embodiment of the present disclosure;

FIG. 7B is a schematic diagram illustrating the overall configuration of a communication system according to another embodiment of the present disclosure; and

FIG. 8 is a sequence diagram illustrating a connection sequence in the communication system according to another embodiment of the present disclosure.

### DETAILED DESCRIPTION OF THE INVENTION

Hereinafter, embodiments of the present disclosure will be described with reference to the accompanying drawings.

### Background of Embodiment

First, the background of the present embodiment will be described to facilitate understanding. When wirelessly connecting a smartwatch to a smartphone using BLE, typically, the smartwatch functioning as a peripheral transmits advertisement signals, while the smartphone functioning as a central scans for wireless signals, and detects the advertisement signals from the smartwatch, thereby establishing wireless connection. This is because the central consumes more power than the peripheral, as the scanning for wireless signals by the central is executed at shorter intervals than the transmission period of advertisement signals in order to ensure reliable detection of the advertisement signals. Hence, the smartphone, which can accommodate a larger power source than the smartwatch, is configured to function as a central.

This mode of connection between the smartwatch and the smartphone poses a problem that the smartwatch functioning as a peripheral can only connect to a single smartphone functioning as a central, due to the BLE specifications. Today, individuals using two smartphones, one for personal use and another for business use, is no longer a rare sight. In such cases, the smartwatch can only connect to one of the smartphones. In order to switch the connection from the personal smartphone to the business smartphone, the connection procedure must be redone using BLE.

In BLE, an electronic device functioning as a central can simultaneously connect to a plurality of peripheral devices, and there is no specified upper limit on the number of connections. Accordingly, configuring the smartwatch to function as a central in BLE connection allows the smartwatch to be connected to and used with a plurality of smartphones. However, when a smartwatch functions as a central to search for a peripheral, scanning to detect advertisement signals must be executed with a period shorter than the transmission period of the advertisement signals. This results in significant power consumption, which poses a problem for electronic devices with limited power capacity, such as smartwatches. The present embodiment addresses the need to reduce power consumption on smartphones when connecting a plurality of smartphones to a smartwatch.

### Configuration of Communication System

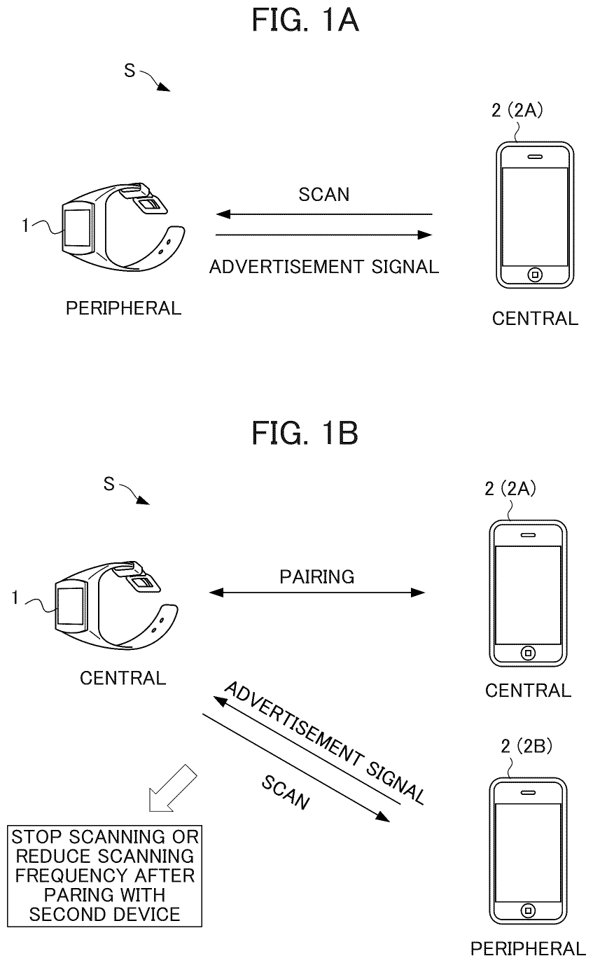

First, with reference to FIGS. 1A and 1B, the configuration of the communication system according to the present embodiment will be described. FIGS. 1A and 1B are schematic diagrams illustrating the overall configuration of the communication system in the present embodiment. A communication system S includes a portable wireless device 1, which is a first electronic device, and a portable terminal device 2, which is a second electronic device. The portable wireless device 1 and the portable terminal device 2 can be connected via BLE. The portable wireless device 1 in the present embodiment is configured as a wristwatch-type electronic device, commonly referred to as a smartwatch, which is worn by a user on their forearm. The portable wireless device 1 is provided with standard time display and timekeeping functions, such as time display, alarms, and timers. Additionally, the portable wireless device 1 may be provided with various measurement functions, including activity tracking functions such as temperature measurement, barometric pressure measurement, heart rate measurement, and pedometer functions. Alternatively, the portable wireless device 1 may be an electronic device such as a fitness tracker without the time display function as a watch, or may be a simple analog or digital watch with the communication function.

The portable terminal device 2 typically refers to a smartphone with a call function. The portable wireless device 1 functioning as a smartwatch is wirelessly connected to the portable terminal device 2 functioning as a smartphone, whereby the portable wireless device 1 functions as a wireless terminal of the portable terminal device 2. Specifically, the portable wireless device 1 can receive notifications for incoming calls, emails, or schedule alerts from the portable terminal device 2. The portable terminal device 2 is not limited to smartphones and may include other mobile terminals such as tablet terminals or electronic devices such as notebook computers, which are provided with the wireless communication function. When individually distinguished, the portable terminal devices 2 are hereinafter referred to as portable terminal devices 2A and 2B.

As illustrated in FIG. 1A, in the present embodiment, the portable wireless device 1 firstly functions as a peripheral and transmits advertisement signals at a predetermined time interval. Specifically, the portable terminal device 2A to be connected functions as a central, and executes passive scanning at a time interval shorter than the time interval for transmitting the advertisement signals. When the portable terminal device 2A detects the advertisement signals from the portable wireless device 1, the portable terminal device 2A is paired with the portable wireless device 1 through the connection processing such as key exchange for encrypted communication. In the present embodiment, the portable wireless device 1 is configured to function as a peripheral, because the time interval for transmitting advertisement signals is longer than the scanning interval when functioning as a central. As a result, power consumption is reduced compared to when the device functions as a central.

FIG. 1B illustrates the state where the portable wireless device 1 is paired with one portable terminal device 2A. The portable wireless device 1 functioning as a peripheral, which has been paired with the portable terminal device 2A, cannot connect to a second portable terminal device 2B in this state. Therefore, when paired with the first portable terminal device 2A, the portable wireless device 1 switches the BLE terminal function to a central. The second portable terminal device 2B is configured to function as a peripheral. In this state, the portable wireless device 1 can detect advertisement signals transmitted from the second portable terminal device 2B through passive scanning. When the portable wireless device 1 detects the advertisement signals from the second portable terminal device 2B functioning as a peripheral, pairing is executed in the same manner as with the first portable terminal device, resulting in the portable wireless device 1 being connected to both portable terminal devices 2A and 2B. In the present embodiment, the upper limit of connections to the portable wireless device 1 is set to two. Thus, upon detecting connections with two portable terminal devices 2A and 2B, the scanning for advertisement signals is stopped, or the frequency of scanning is reduced, thereby allowing for suppressing power consumption.

### Hardware Configuration Example of Portable Wireless Device 1

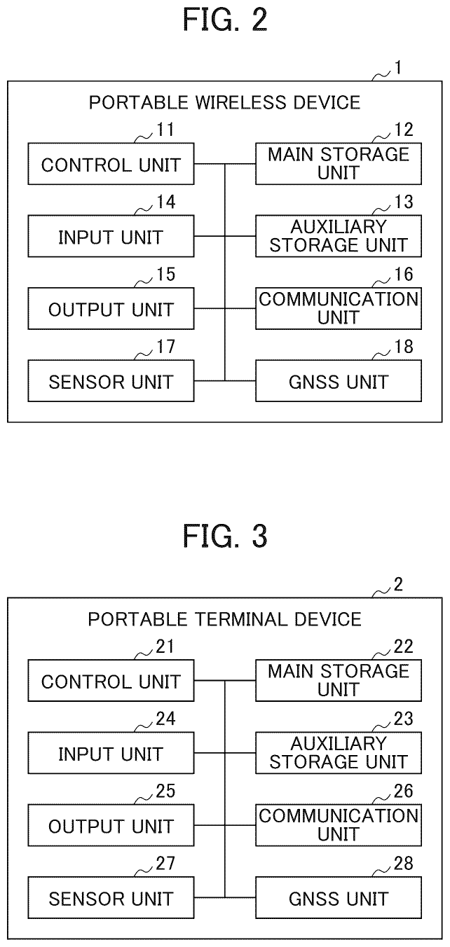

Next, the configuration of the portable wireless device 1 in the present embodiment will be described. FIG. 2 is a block diagram illustrating the hardware configuration of the portable wireless device 1 according to one embodiment of the present disclosure. As illustrated in FIG. 2, the portable wireless device 1 in the present embodiment includes a control unit 11, a main storage unit 12, an auxiliary storage unit 13, an input unit 14, an output unit 15, a communication unit 16, a sensor unit 17, and a GNSS unit 18.

The hardware components illustrated in FIG. 2 will now be described. The control unit 11 is configured by a processor that executes various computation and control processing necessary for the operation of the portable wireless device 1. The control unit 11 may also be referred to as a processor. The processor configuring the control unit 11 may be a Central Processing Unit (CPU), Micro Processing Unit (MPU), System on a Chip (SoC), Digital Signal Processor (DSP), Graphics Processing Unit (GPU), Application Specific Integrated Circuit (ASIC), Programmable Logic Device (PLD), Field-Programmable Gate Array (FPGA), or a combination thereof. The control unit 11 may also be a combination of such processors with hardware accelerators or similar components.

The main storage unit 12 stores programs such as firmware, system software, and application software, and also functions as a work area temporarily used for various processing tasks. The main storage unit 12 may be configured by non-volatile memory such as Read-Only Memory (ROM) and volatile memory such as Random Access Memory (RAM).

The auxiliary storage unit 13 stores data such as contact information, phone numbers, email addresses, and various application programs. The auxiliary storage unit 13 may be configured by semiconductor memory or similar components.

The input unit 14 is configured by, for example, touch panels, various buttons such as keys, and microphones, and receives user operations. The output unit 15 is configured by displays, such as touch panels for displaying images, and speakers for amplifying audio, and outputs images and sound.

The communication unit 16 controls wireless communication between the portable wireless device 1 and external devices. In the present embodiment, the communication unit 16 includes, for example, a BLE module that supports wireless communication with the portable terminal device 2. The BLE module configures the portable wireless device 1 to function as either a central or a peripheral in conformity with the BLE communication standard. The communication unit 16 may also include wireless communication devices in conformity with the communication standards such as a SIM (Subscriber Identity Module) card, network connection devices such as network adapters, Wi-Fi (registered trademark) (Wireless Fidelity), and NFC (Near Field Communication).

The sensor unit 17 includes various sensors that detect the user's condition and movements. The sensor unit 17 may be configured by, for example, sensors such as an acceleration sensor, an angular velocity sensor, a geomagnetic sensor, a pressure sensor, and a heart rate sensor. The acceleration sensor, the angular velocity sensor, the geomagnetic sensor, and the pressure sensor can configure the sensor unit 17 to function as a behavior detection unit for detecting the user's movement, or as a positioning unit in conjunction with the GNSS unit 18 described below. The heart rate sensor can configure the sensor unit 17 to function as a biometric information acquisition unit for acquiring the user's heart rate as biometric information.

The GNSS unit 18 is a positioning information acquisition unit for acquiring location information. GNSS stands for Global Navigation Satellite System, and the GNSS unit 18 is a satellite positioning device that utilizes satellite positioning systems such as GPS (Global Positioning System). The GNSS unit 18 is configured with an antenna and electronic components, acquires positioning satellite signals transmitted from a plurality of positioning satellites, and determines its own location.

### Hardware Configuration Example of Portable Terminal Device 2

Next, the configuration of the portable terminal device 2 in the present embodiment will be described. As illustrated in FIG. 3, the portable terminal device 2 in the present embodiment includes a control unit 21, a main storage unit 22, an auxiliary storage unit 23, an input unit 24, an output unit 25, a communication unit 26, a sensor unit 27, and a GNSS unit 28. Since the hardware configuration of the portable terminal device 2 is equivalent to that of the portable wireless device 1 which is a computer provided with the communication function, redundant descriptions of the individual components will be omitted.

### Functional Configuration Example of Portable Wireless Device 1

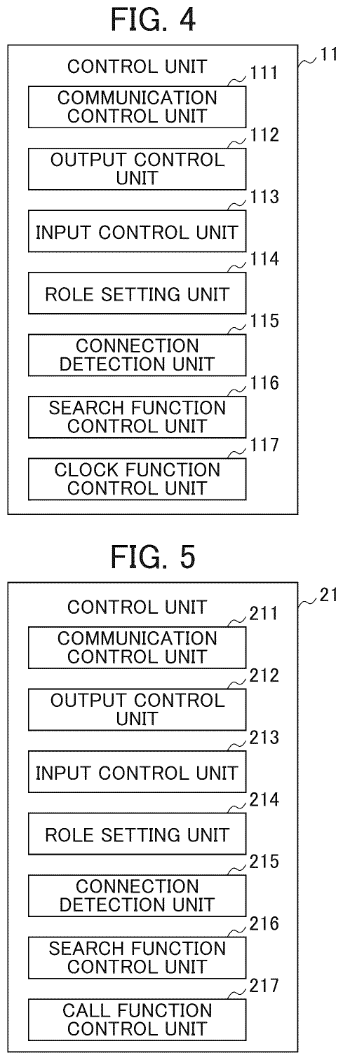

Next, the functions implemented by the control unit 11 of the portable wireless device 1 will be described. FIG. 4 is a block diagram illustrating the functions implemented by the control unit 11 of the portable wireless device 1 in one embodiment of the present disclosure. The control unit 11 in the present embodiment includes a communication control unit 111, an output control unit 112, an input control unit 113, a role setting unit 114, a connection detection unit 115, a search function control unit 116, and a clock function control unit 117.

The communication control unit 111 executes the processing for communication between the portable wireless device 1 and the external devices via the communication unit 16. For example, in the present embodiment, the communication control unit 111 controls wireless communication with the portable wireless device 2 in conformity with the BLE communication standard. The BLE module provided in the communication unit 16 functions as a peripheral to transmit advertisement signals, or functions as a central to control the passive scanning processing for detecting advertisement signals transmitted from the peripheral. The advertisement signals can be transmitted at a time interval appropriately set to, for example, 100 ms, and may also be transmitted at a time interval including at least a first time interval, which can vary as appropriate. In order to ensure quick and reliable detection of advertisement signals, the scanning interval for the advertisement signals may be defined as a time interval including at least a second time interval shorter than the first time interval.

The output control unit 112 executes the processing for displaying images on the screen of the output unit 15. For example, the output control unit 112 executes the processing for displaying a clock in various display modes, and displaying various notification images from the connected portable terminal device 2 on the screen of the output unit 15. The output control unit 112 executes the processing for outputting audio through the output unit 15, such as call audio, various notifications, and alarms received from the connected portable terminal device 2.

The input control unit 113 executes the processing for receiving the user operations on the input unit 14. For example, the input control unit 113 executes the processing for receiving the user input operations through the input unit 14, based on the operations on the screen displayed on the output unit 15 or the operations of the input keys and buttons.

The role setting unit 114 has the functions to provide setting instructions to the communication control unit 111 regarding whether the portable wireless device 1 should function as a central or peripheral. Details on how the role setting is executed will be described later in relation to data processing.

The connection detection unit 115 is provided with the functions to detect a state of connection between the portable wireless device 1 and the portable terminal device 2, and to notify the communication control unit 111 and the role setting unit 114 of the detection. For example, the connection detection unit 115 detects whether no portable terminal device 2 is connected, one portable terminal device 2 is connected, or two portable terminal devices 2 are connected. The state of connection with the portable terminal device 2, as detected by the connection detection unit 115, may be notified to the user by displaying an icon on the screen of the output unit 15 or by outputting audio upon changing the state of connection. Alternatively, immediately after detecting a connection with one portable terminal device 2, or when a predetermined period has elapsed without detecting a connection with a second portable terminal device 2 after connecting the one portable terminal device 2, the connection detection unit 115 may execute screen display or audio output of information prompting the user to connect a second portable terminal device 2. Such notification processing for the user may issue a notification prompting the user to connect a second portable terminal device 2 immediately after detecting a connection with the first portable terminal device 2, and reissue this notification after a predetermined period has elapsed since the first notification. This allows for preventing the user from unintentionally forgetting to connect a second device. For the second notification, the preventive effect can be further enhanced by adopting screen display or audio output that conveys a greater sense of urgency to the user, such as modifying the notification content or increasing the number of alarm sounds. When only one portable terminal device 2 is connected, in a case where the portable wireless device 1 has a screen display function similar to that of a smartwatch, while the portable wireless device 1 functioning as a central is scanning for a second portable terminal device 2, the power-saving processing such as dimming the display screen may be executed in order to reduce power consumption.

The search function control unit 116 controls the search function of the portable wireless device 1 for the portable terminal device 2, based on the role setting of the portable wireless device 1 by the role setting unit 114 and the state of connection with the portable terminal device 2.

When the portable wireless device 1 functions as a smartwatch, the clock function control unit 117 controls the clock function of the portable wireless device 1 as a smartwatch, such as time display, alarms, and timers.

### Functional Configuration Example of Portable Terminal Device 2

Next, the functions implemented by the control unit 21 of the portable terminal device 2 will be described. FIG. 5 is a block diagram illustrating the functions implemented by the control unit 21 of the portable terminal device 2 in one embodiment of the present disclosure. The control unit 21 in the present embodiment includes a communication control unit 211, an output control unit 212, an input control unit 213, a role setting unit 214, a connection detection unit 215, a search function control unit 216, and a call function control unit 217.

The communication control unit 211 executes processing that enable the portable terminal device 2 to communicate with external devices such as the portable wireless device 1 through the communication unit 26. For example, in the present embodiment, the communication control unit 211 controls wireless communication with the portable wireless device 1 in conformity with the BLE communication standard. The BLE module provided in the communication unit 26 functions as a peripheral to transmit advertisement signals, or functions as a central to control the passive scanning processing for detecting the advertisement signals transmitted from a peripheral.

The output control unit 212 executes processing for displaying images on the screen of the output unit 25. For example, the output control unit 212 executes processing for displaying images output from various application programs, which are installed and operating on the portable terminal device 2 functioning as a smartphone, on the screen of the output unit 25. The output control unit 212 executes processing for outputting audio, such as call audio, various notifications, and alarms, through the output unit 25.

The input control unit 213 executes processing for receiving the user operations on the input unit 24. For example, the input control unit 213 executes processing for receiving the input operations executed by the user through the input unit 24, based on operating the operation screen displayed on the output unit 25 or the input keys and buttons.

The role setting unit 214 has the functions to provide setting instructions to the communication control unit 211 regarding whether the portable terminal device 2 should be configured to function as a central or peripheral. Details on how the role setting is executed will be described later in relation to data processing.

The connection detection unit 215 has the function to detect the state of connection between the portable wireless device 2 and the portable terminal device 1, and notify the communication control unit 211 and the role setting unit 214 of the detection. For example, the connection detection unit 215 detects whether the portable terminal device 2 is connected to the portable wireless device 1.

The search function control unit 216 controls the search function of the portable terminal device 2 for the portable wireless device 1, based on the role setting of the portable terminal device 2 by the role setting unit 214 and the state of connection with the portable wireless device 1.

When the portable terminal device 2 functions as a smartwatch, the call function control unit 217 controls the clock function of the portable terminal device 2 as a smartwatch, such as time display, alarms, and timers.

The functions of the role setting unit 214, the connection detection unit 215, and the search function control unit 216 can be implemented by installing application programs for managing and controlling the exchange of information and operational coordination with the portable wireless device 1, on the portable terminal device 2 that is embodied as a smartphone.

### Wireless Communication Connection Control Function in Present Embodiment

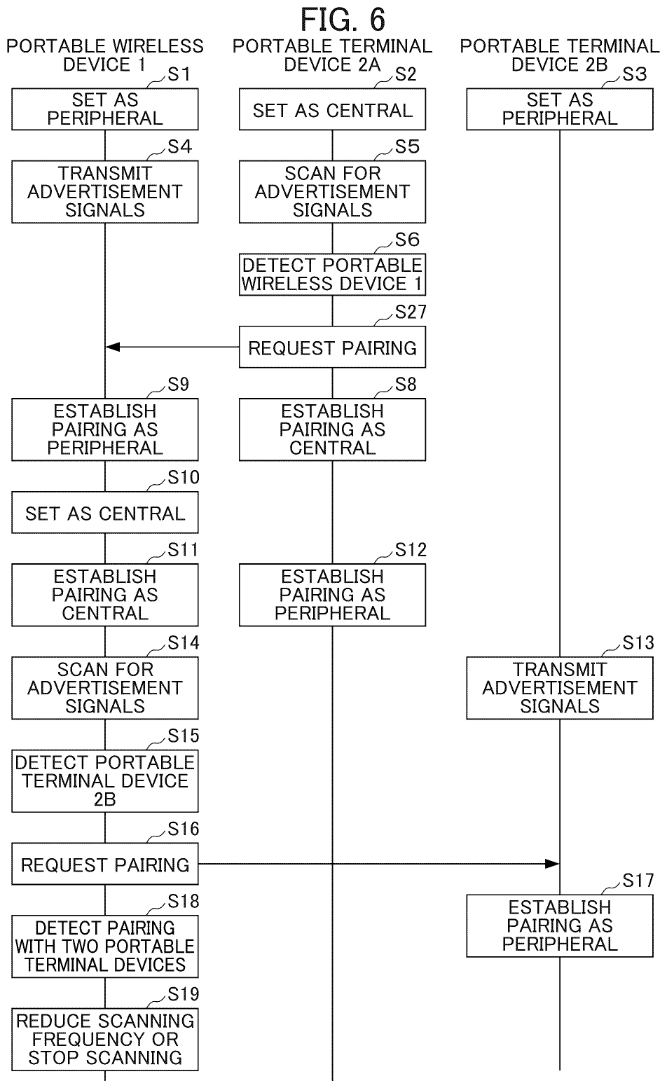

Next, the wireless communication connection processing in conformity with the BLE communication standard will be described, which is executed by the communication system S of the present embodiment, including the portable wireless device 1 and the portable terminal device 2. FIG. 6 illustrates a sequence diagram illustrating an example of the procedure for wireless communication connection processing executed in the communication system S of the present embodiment, as exemplified in FIGS. 1A and 1B. The communication system S includes one portable wireless device 1 and two portable terminal devices 2. Here, the two portable terminal devices 2 are referred to as a portable terminal device 2A and a portable terminal device 2B.

The wireless communication connection control processing illustrated in FIG. 6 is primarily executed by the communication control units 111, 211, the role setting units 114, 214, the connection detection units 115, 215, and the search function control units 116, 216, which are included in the portable wireless device 1 and the portable terminal devices 2.

The wireless communication connection processing sequence illustrated in FIG. 6 is executed continuously after the portable wireless device 1 is powered on and the operation begins.

In Step S1, the role setting unit 114 of the portable wireless device 1 configures the communication control unit 111 to operate as a peripheral in conformity with the BLE communication standard. In Step S2, the role setting unit 214 sets the communication control unit 211 of the portable terminal device 2A to function as a central. In Step S3, the role setting unit 214 sets the communication control unit 211 of the portable terminal device 2B to function as a peripheral.

In Step S4, the portable wireless device 1 functioning as a peripheral transmits advertisement signals. In Step S5, the portable terminal device 2A functioning as a central scans for advertisement signals.

In Step S6, the portable terminal device 2A detects the advertisement signals from the portable wireless device 1, then in Step S7, the portable terminal device 2A requests pairing with the portable wireless device 1. Subsequently, connection processing, including key exchange for encrypted communication, is executed between the portable terminal device 2A and the portable wireless device 1. As a result, in Step S8, the pairing with the portable terminal device 2A as a central is established, and in Step S9, the pairing with the portable wireless device 1 as a peripheral is established.

In Step S10, when the connection detection unit 115 of the portable wireless device 1 detects a connection with one portable terminal device 2A, the role setting unit 114 switches the setting of the communication control unit 111 from a peripheral to a central in conformity with the BLE communication standard. In this case, in the portable wireless device 1 and the portable terminal device 2A, which have already been paired with each other, the portable wireless device 1 is paired as a central and the portable terminal device 2A is paired as a peripheral (Steps S11 and S12). The second portable terminal device 2B functioning as a peripheral transmits advertisement signals (Step S13). In Step S14, the portable wireless device 1 executes scanning to detect advertisement signals, and upon detecting the advertisement signals from the portable terminal device 2B in Step S15, transmits a pairing request (Step S16).

In Step S17, upon receiving the pairing request, the communication control unit 211 of the portable terminal device 2B establishes pairing with the portable wireless device 1 functioning as a peripheral. In Step S18, the connection detection unit 115 of the portable wireless device 1 notifies the search function control unit that the pairing with the second portable terminal device 2B has been detected. In Step S19, based on the connection between the two portable terminal devices 2A and 2B, the search function control unit of the portable wireless device 1 stops scanning for advertisement signals as a central. In this case, the portable wireless device 1 may suppress power consumption by setting the scanning interval for detecting advertisement signals to be longer than the time interval for transmitting the advertisement signals. In an event in which the second portable terminal device 2B is not connected even after a predetermined period has elapsed since the connection with the first portable terminal device 2A, and this event is detected a predetermined number of times, the portable wireless device 1 may terminate the scanning for wireless signals. In a case where the advertisement signals from the second portable terminal device 2B are not detected within a predetermined period, the scanning may be stopped, or screen display or audio output may be executed to notify the user that another portable terminal device 2 can still be connected. In a case where the power or the Bluetooth setting of the second portable terminal device 2B is turned off, the user should take action such as turning on the power or the Bluetooth setting of the portable terminal device 2B. Therefore, the user is prompted to minimize the duration of power consumption in the scanning for advertisement signals from the second portable terminal device 2B. In cases where the advertisement signals from the second portable terminal device 2B are not detected within a predetermined period, or such non-detection of advertisement signals within a predetermined period occurs a predetermined number of times, the upper limit of connections to the portable wireless device 1 may be changed to one. This can prevent unnecessary power consumption caused by continuous scanning, even when the user does not intend to connect a second portable terminal device 2B. The setting the upper limit of connections to one may be cancelled, based on predetermined conditions, such as the change of the date.

For example, conventional technologies such as those disclosed in Japanese Patent Application Publication No. 2020-114032 consider configurations in which one imaging device is BLE-connected to one portable terminal, and do not take into account configurations in which a plurality of smartphones are connected to a single smartwatch.

According to the embodiment described above, the portable wireless device 1 functioning as a peripheral transmits advertisement signals at a time interval longer than the time interval for scanning by the central, thereby allowing for reducing power consumption. Upon reaching the upper limit of connections by detecting a connection with the second portable terminal device 2B, the time interval for scanning to detect advertisement signals can be extended, or the scanning can be stopped, whereby the power consumption can be further reduced or stopped.

### Description of Another Embodiment

Next, another embodiment, which is a variation of the previously described embodiment, will be described. In this embodiment, the hardware configuration and functional blocks of the portable wireless device 1 and the portable terminal device 2 are the same as those in the previous embodiment, thus the description is omitted.

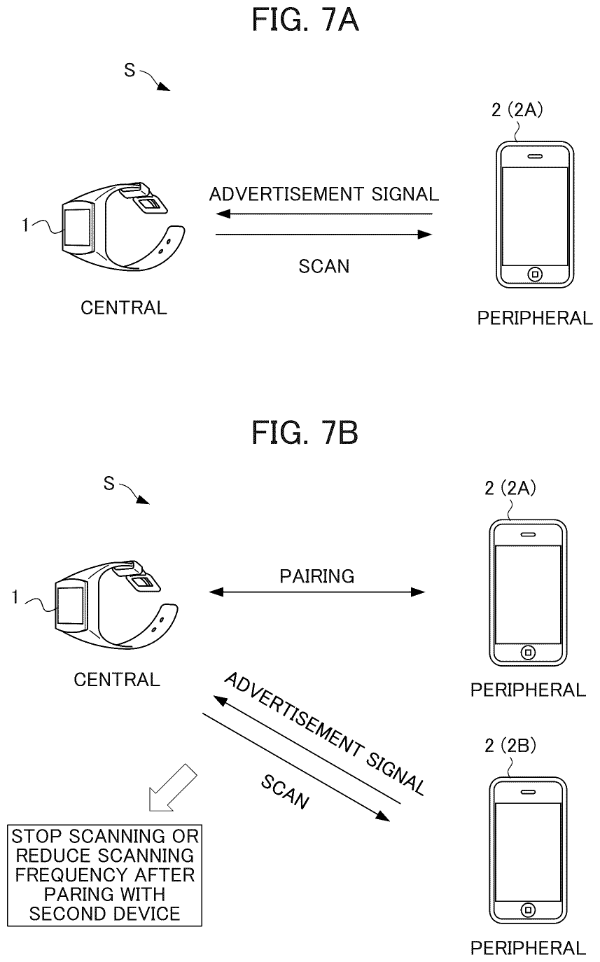

In the present embodiment as a variation, as illustrated in FIG. 7A, the portable wireless device 1 functions as a central for BLE-connection, and can connect to a plurality of peripherals in conformity with the BLE standard. The portable terminal device 2A functioning as a peripheral transmits advertisement signals at a predetermined time interval in conformity with the BLE standard. The advertisement signals are transmitted to the central for search, using three of the 40 channels available in the 2.4 GHZ BLE band. The central executes scanning to detect the advertisement signals transmitted from the peripheral. Passive scanning is adopted as a scanning method in order to reduce power consumption. The time interval for executing passive scanning is set to be shorter than the time interval for transmitting the advertisement signals from the peripheral. The purpose of this setting is to detect the advertisement signals more quickly and reliably. In the state illustrated in FIG. 7A, when the portable wireless device 1 detects the advertisement signals from the portable terminal device 2A, the portable wireless device 1 executes processing for connection with the portable terminal device 2, including key exchange for encrypted communication, thereby completing the pairing.

FIG. 7B illustrates the state in which the portable wireless device 1 is paired with one portable terminal device 2A. In this state, the portable wireless device 1 functioning as a central executes scanning to detect the second portable terminal device 2B. When the portable wireless device 1 detects the advertisement signals from the second portable terminal device 2B functioning as a peripheral, the pairing is executed similarly to the pairing with the first device, whereby the portable wireless device 1 is connected to the two portable terminal devices 2A and 2B. In the present embodiment, the upper limit of connections to the portable wireless device 1 is set to two. Thus, upon detecting connections with two portable terminal devices 2A and 2B, the portable wireless device 1 stops scanning for advertisement signals, or reduces the frequency of scanning, thereby allowing for suppressing power consumption.

### Wireless Communication Connection Control Function in Present Embodiment

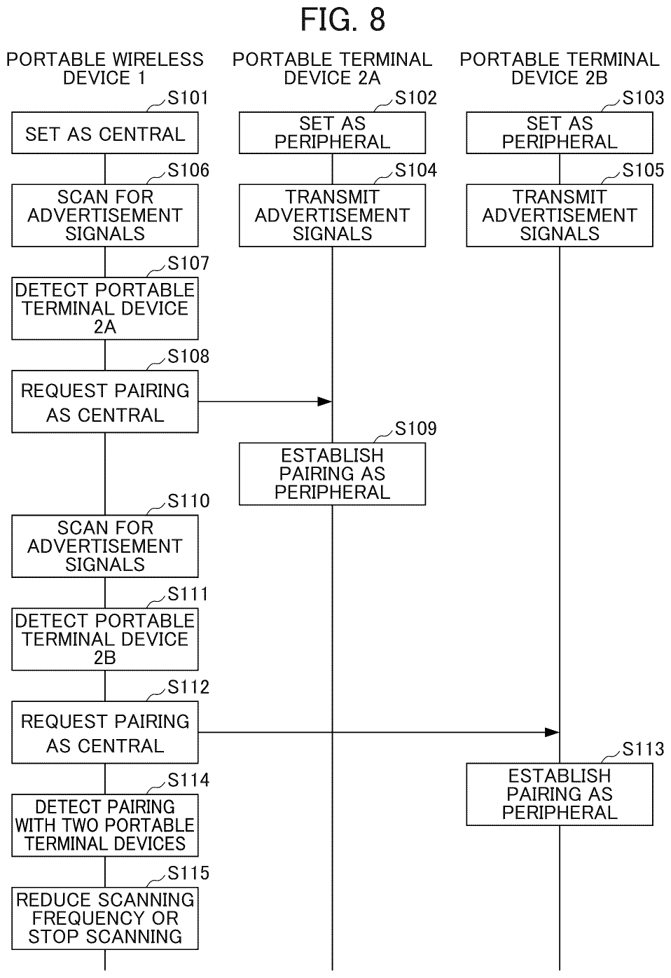

Next, the wireless communication connection processing in conformity with the BLE communication standard will be described, which is executed by the communication system S including the portable wireless device 1 and the portable terminal device 2 of the present embodiment. FIG. 8 illustrates a sequence diagram illustrating an example of the procedure for wireless communication connection processing executed in the communication system S of the present embodiment, as exemplified in FIGS. 7A and 7B. The communication system S includes one portable wireless device 1 and two portable terminal devices 2. Here, the two portable terminal devices 2 are referred to as a portable terminal device 2A and a portable terminal device 2B.

The wireless communication connection control processing illustrated in FIG. 8 is primarily executed by the communication control units 111, 211, the role setting units 114, 214, the connection detection units 115, 215, and the search function control units 116, 216, which are included in the portable wireless device 1 and the portable terminal devices 2.

The wireless communication connection processing sequence illustrated in FIG. 8 is continuously executed, after the portable wireless device 1 is powering on and the operation begins.

In Step S101, the role setting unit 114 of the portable wireless device 1 configures the communication control unit 111 to operate as a central in conformity with the BLE communication standard. In Step S102, the role setting unit 214 configures the communication control unit 211 of the portable terminal device 2A to function as a peripheral. In Step S103, the role setting unit 214 configures the communication control unit 211 of the portable terminal device 2B to function as a peripheral.

In Step S104, the portable terminal device 2A functioning as a peripheral transmits advertisement signals. In Step S105, the portable terminal device 2B functioning as a peripheral transmits advertisement signals. In Step S106, the portable wireless device 1 functioning as a central scans for advertisement signals.

In Step S107, the portable wireless device 1 detects the advertisement signals from the portable terminal device 2A, and in Step S108, the portable wireless device 1 transmits a pairing request to the portable terminal device 2A. Subsequently, the connection processing, including key exchange for encrypted communication, is executed between the portable terminal device 2A and the portable wireless device 1. As a result, in Step S108, the paring with the portable wireless device 1 as a central is established, and in Step S109, the paring with the portable terminal device 2A as a peripheral is established. This pairing is maintained thereafter.

In Step S110, the portable wireless device 1 executes scanning to detect advertisement signals, and in Step S111, upon detecting the advertisement signals from the portable terminal device 2B, transmits a pairing request (Step S112).

In Step S113, upon receiving the pairing request, the communication control unit 211 of the portable terminal device 2B functioning as a peripheral establishes pairing with the portable wireless device 1. In Step S114, the connection detection unit 115 of the portable wireless device 1 notifies the search function control unit that the pairing with the second portable terminal device 2B has been detected. In Step S115, based on the connection between the two portable terminal devices 2A and 2B, the search function control unit 116 of the portable wireless device 1 functioning as a central stops scanning for advertisement signals. In this case, the portable wireless device 1 may set the interval for scanning to detect advertisement signals to be longer than the time interval for transmitting the advertisement signals, thereby suppressing power consumption. In an event in which the second portable terminal device 2B is not connected even after a predetermined period has elapsed since the connection with the first portable terminal device 2A, and this event is detected a predetermined number of times, the portable wireless device 1 may terminate the scanning for wireless signals. The alternative processing from Step S14 onward (FIG. 6) by the portable wireless device 1 to scan for the second portable terminal device 2B in the first embodiment can also be applied to the processing from Step S110 onward (FIG. 8) in the present embodiment.

For example, Japanese Patent Application Publication No. 2020-114032 proposes a configuration, in which a camera device is BLE-connected to a portable terminal, and the advertising interval for reconnection is adjusted based on usage conditions, thereby reducing power consumption. According to the embodiment described above, upon reaching the upper limit of connections by detecting a connection with the second portable terminal device 2B, the time interval for scanning to detect advertisement signals can be extended, or the scanning can be stopped, whereby the power consumption can be further suppressed or stopped.

The present embodiment as described above relates to a communication method for a communication system S including: the portable wireless device 1 including the control unit 11 and the communication unit 16 that executes wireless communication; the portable terminal device 2A including the control unit 21 and the communication unit 26 that executes wireless communication; and the portable terminal device 2B including the a control unit 21 and the communication unit 26 that executes wireless communication. The control unit 11 of the portable wireless device 1 causes the communication unit 16 to transmit a wireless signal, which is a signal repetitively output at a time interval including at least a first time interval. The control unit 21 of the portable terminal device 2A causes the communication unit 26 to connect the portable wireless device 1 and the portable terminal device 2A, based on the scanning for the wireless signals. The control unit 11 of the portable wireless device 1 scans for the wireless signals at a time interval including at least a second time interval shorter than the first time interval to connect with the portable terminal device 2B, based on the connection between the portable wireless device 1 and the portable terminal device 2A.

In this manner, the portable wireless device 1 can connect to the plurality of portable terminal devices 2A and 2B, such as smartphones, while suppressing power consumption.

The control unit 11 of the portable wireless device 1 may connect the portable wireless device 1 and the portable terminal device 2B by the communication unit 26, based on the scanning for the wireless signals, and may terminate the scanning for the wireless signals, based on the connection between the portable wireless device 1 and the portable terminal device 2B.

In this manner, power consumption of the portable wireless device 1 can be further reduced.

Regarding the portable wireless device 1 and the portable terminal devices 2A and 2B, the control unit 21 of the portable terminal device 2A may cause the communication unit 26 to transmit wireless signals, which are intermittent signals with a first period. After connecting the portable wireless device 1 and the portable terminal device 2A, based on the scanning for the wireless signals, the control unit 11 of the portable wireless device 1 may cause the communication unit 26 to connect the portable wireless device 1 and the portable terminal device 2B, based on the scanning for the wireless signals, which is an intermittent signal with the first period transmitted from the communication unit 26 of the portable terminal device 2B.

In this manner, the portable wireless device 1 can connect to the plurality of portable terminal devices 2A and 2B, such as smartphones, while suppressing power consumption.

The control unit 11 of the portable wireless device 1 may terminate the scanning for the wireless signals, based on the connection between the portable wireless device 1 and the portable terminal device 2B.

In this manner, power consumption of the portable wireless device 1 can be further reduced.

In the above, in an event in which the portable terminal device 2B is not connected even after a predetermined period has elapsed since the connection with the portable terminal device 2A, and this event is detected a predetermined number of times, the control unit 11 of the portable wireless device 1 may terminate the scanning for the wireless signals.

In this manner, power consumption of the portable wireless device 1 to search for the portable terminal device 2B can be reduced.

In a case of determining that a predetermined period has elapsed since the connection with the portable terminal device 2A, the portable wireless device 1 may execute screen display or audio output of information prompting the user to connect the portable terminal device 2B.

In this manner, the user of the portable wireless device 1 can recognize non-connection with the second portable terminal device 2B, and take necessary actions such as powering on the second portable terminal device 2B.

According to the present embodiment, the communication system S includes: the portable wireless device 1 including the control unit 11 and the communication unit 16 that executes wireless communication; the portable terminal device 2A including the control unit 21 and the communication unit 26 that executes wireless communication; and the portable terminal device 2B including the control unit 21 and the communication unit 26 that executes wireless communication. The control unit 11 of the portable wireless device 1 causes the communication unit 16 to transmit a wireless signal, which is a signal repetitively output at a time interval including at least a first time interval. The control unit 21 of the portable terminal device 2A causes the communication unit 26 to connect the portable wireless device 1 and the portable terminal device 2A, based on the scanning for the wireless signals. The control unit 11 of the portable wireless device 1 scans for the wireless signals for connecting with the portable terminal device 2B, at a time interval including at least a second time interval shorter than the first time interval, based on the connection between the portable wireless device 1 and the portable terminal device 2A.

In this manner, the same effects as those of the communication method according to the embodiment described above can be achieved.

The present embodiment also includes the portable wireless device 1 included in the communication system S, as well as the program causing a processor to execute the control method for the portable wireless device 1.

The series of processing described above can be executed by hardware or software. In other words, the functional configuration illustrated in FIG. 5 is merely an example and is not limited to this. That is, the portable wireless device 1 only needs to include the functions capable of executing the series of processing described above as a whole. The functional blocks used to implement the functions are not limited to the example illustrated in FIG. 5. A single functional block may be configured solely by hardware, solely by software, or by a combination of both. The functional configuration in the present embodiment is implemented by a processor that executes arithmetic processing. Processors that can be used in the present embodiment include not only an individual processing device such as a single processor, a multiprocessor, and a multicore processor, but also combinations of these processing devices with processing circuits such as ASICs (Application Specific Integrated Circuits) and FPGAs (Field-Programmable Gate Arrays).

In this specification, the steps describing data processing executed by the portable wireless device 1 and the portable terminal devices 2A and 2B include not only processing that are executed chronologically in accordance with their sequence but also processing that are executed in parallel or individually without being executed chronologically.

While several embodiments of the present disclosure have been described, these embodiments are merely examples and do not limit the technical scope of the present invention. The present disclosure may take various other embodiments, and the configurations of the embodiments and variations described above may also be combined. Furthermore, various changes, such as omissions or substitutions, can be made without departing from the spirit of the present disclosure. These embodiments and their variations are included in the scope and spirit of the disclosure described in this specification and the scope of the claims and their equivalents.

What is claimed is:

1. A method for a system that includes:
a first electronic device including a first processor and a first communication device that executes wireless communication;
a second electronic device including a second processor and a second communication device that executes wireless communication; and
a third electronic device including a third processor and a third communication device that executes wireless communication,
the method comprising:
transmitting, by the first processor of the first electronic device, a wireless signal, which is a signal repetitively output at a time interval including at least a first time interval, via the first communication device;
connecting, by the second processor of the second electronic device, the first electronic device and the second electronic device via the second communication device, based on scanning for the wireless signal; and
scanning, by the first processor, for the wireless signal for connecting with the third electronic device, repetitively at a time interval including at least a second time interval shorter than the first time interval, based on connection between the first electronic device and the second electronic device.

2. The method according to claim 1, further comprising:
connecting, by the first processor, the first electronic device and the third electronic device via the third communication device, based on scanning for the wireless signal; and
terminating, by the first processor, the scanning for the wireless signal, based on connection between the first electronic device and the third electronic device.

3. The method according to claim 1, further comprising:
terminating, by the first processor, the scanning for the wireless signal, in a case of detecting an event a predetermined number of times, in which the third electronic device is not connected even after a predetermined period has elapsed since connecting with the second electronic device.

4. The method according to claim 1, further comprising:
transmitting, by the second processor, a wireless signal, which is a signal repetitively output at a time interval including at least the first time interval, via the second communication device; and
connecting, by the first processor, the first electronic device and the third electronic device via the third communication device, based on scanning for the wireless signal, which is a signal repetitively output at a time interval including at least the first time interval and transmitted by the third communication device of the third electronic device, after connecting the first electronic device and the second electronic device, based on scanning for the wireless signal.

5. The method according to claim 4, further comprising:
terminating, by the first processor, the scanning for the wireless signal, based on connection between the first electronic device and the third electronic device.

6. The method according to claim 4, further comprising:
terminating, by the first processor, the scanning for the wireless signal, in a case of detecting an event a predetermined number of times, in which the third electronic device is not connected even after a predetermined period has elapsed since connecting with the second electronic device.

7. The method according to claim 1, further comprising:
executing, by the first electronic device, screen display or audio output of information prompting a user to connect the third electronic device, in a case of determining that a predetermined period has elapsed since connecting with the second electronic device.

8. A communication system, comprising:
a first electronic device including a first processor and a first communication device that executes wireless communication;
a second electronic device including a second processor and a second communication device that executes wireless communication; and
a third electronic device including a third processor and a third communication device that executes wireless communication, wherein
the first processor is configured to transmit a wireless signal, which is a signal repetitively output at a time interval including at least a first time interval, via the first communication device,
the second processor is configured to connect the first electronic device and the second electronic device via the second communication device, based on scanning for the wireless signal, and
the first processor is configured to scan for the wireless signal for connecting with the third electronic device, at a time interval including at least a second time interval shorter than the first time interval, based on the connection between the first electronic device and the second electronic device.

9. The communication system according to claim 8, wherein the first processor connects the first electronic device and the third electronic device via the third communication device, based on scanning for the wireless signal, and terminates the scanning for the wireless signal, based on connection between the first electronic device and the third electronic device.

10. The communication system according to claim 8, wherein the first processor terminates the scanning for the wireless signal, in a case of detecting an event a predetermined number of times, in which the third electronic device is not connected even after a predetermined period has elapsed since connecting with the second electronic device.

11. The communication system according to claim 8, wherein
the second processor transmits the wireless signal, which is a signal repetitively output at a time interval including at least the first time interval, via the second communication device, and
the first processor connects the first electronic device and the third electronic device via the third communication device, based on scanning for the wireless signal, which is a signal repetitively output at a time interval including at least the first time interval and transmitted by the third communication device of the third electronic device, after connecting the first electronic device and the second electronic device, based on scanning for the wireless signal.

12. The communication system according to claim 11, wherein the first processor terminates the scanning for the wireless signal, based on the connection between the first electronic device and the third electronic device.

13. The communication system according to claim 11, wherein the first processor terminates the scanning for the wireless signal, in a case of detecting an event a predetermined number of times, in which the third electronic device is not connected even after a predetermined period has elapsed since connecting with the second electronic device.

14. The communication system according to claim 8, wherein the first electronic device executes screen display or audio output of information prompting the user to connect the third electronic device, in a case of determining that a predetermined period has elapsed since connecting with the second electronic device.

15. A first electronic device, comprising:
a first processor; and
a first communication unit that executes wireless communication, wherein
the first electronic device is capable of communicating with:
a second electronic device including a second processor and a second communication unit that executes wireless communication; and
a third electronic device including a third processor and a third communication unit that executes wireless communication, wherein
the first processor is configured to:
transmit, via the first communication unit, a wireless signal, which is a signal repetitively output at a time interval including at least a first time interval;
connect with the second electronic device via the second communication unit, based on scanning for the wireless signal by the second processor of the second electronic device; and
execute scanning to connect with the third electronic device, repetitively at a time interval including at least a second time interval shorter than the first time interval, based on the connection between the first electronic device and the second electronic device.
